(19) United States
(12) Patent Application Publication
(10) Pub. No.: US 2005/0263977 A1
(43) Pub. Date: Dec. 1, 2005

(54) METHOD OF PREVENTING FIRMWARE PIRACY

(76) Inventor: Tien-Hui Pan, Tao-Yuan Hsien (TW)

Correspondence Address: NORTH AMERICA INTELLECTUAL PROPERTY CORPORATION, P.O. BOX 506, MERRIFIELD, VA, 22116, US

(21) Appl. No.: 10/709,549

(22) Filed: May 13, 2004

(51) Int. Cl. G06F 9/00

(52) U.S. Cl. 280/201

(57) ABSTRACT

A method of preventing firmware from being pirated. The firmware contains executable code for an electronic device. The method includes ciphering executable firmware code into ciphered firmware code, storing the ciphered firmware code in a nonvolatile memory of the electronic device, and storing a decipher key in a decrypting circuit of the electronic device. The method also includes deciphering the ciphered firmware code with the decrypting circuit of the electronic device to decode the executable firmware code, storing the executable firmware code in a volatile memory of the electronic device, and executing the executable firmware code stored in the volatile memory for operating the electronic device.

### BACKGROUND OF INVENTION

1. Field of the Invention

The present invention relates to firmware of an electronic device, and more specifically, to a method for ciphering firmware to prevent the firmware from being pirated.

2. Description of the Prior Art

Software or information piracy is the activity of using or making copies of software or information without the authorization of the creator or legitimate owner of that software or information. Piracy is most prevalent in the computer software application industry where people frequently make unlicensed illegal copies of a software application. The application may be copied for personal use or for reproduction and commercial profit.

Another area that is susceptible to piracy is firmware used to operate electronic devices such as optical disk drives or hard drives. The firmware for these electronic devices is typically stored in a nonvolatile memory of the electronic device such as a flash memory, a ROM, or an EEPROM. The firmware can be copied very easily by anyone who reads the contents of the nonvolatile memory. For example, suppose a company wishes to see the firmware for a digital versatile disc (DVD) recorder drive made by a competitor. The firmware in the DVD recorder can very easily be copied, allowing the executable code of the firmware to be viewed and analyzed. Since most creators of firmware prefer to keep the contents of the firmware secret, a method of encrypting the firmware is needed to keep competitors from being able to obtain the executable code of the firmware.

### SUMMARY OF INVENTION

It is therefore an objective of the claimed invention to introduce a method for preventing firmware from being copied in order to solve the above-mentioned problems.

According to the claimed invention, a method of preventing firmware from being pirated is proposed. The firmware contains executable code for an electronic device. The method includes ciphering executable firmware code into ciphered firmware code, storing the ciphered firmware code in a nonvolatile memory of the electronic device, and storing a decipher key in a decrypting circuit of the electronic device. The method also includes deciphering the ciphered firmware code with the decrypting circuit of the electronic device to decode the executable firmware code, storing the executable firmware code in a volatile memory of the electronic device, and executing the executable firmware code stored in the volatile memory for operating the electronic device.

It is an advantage of the claimed invention that the firmware code stored in the nonvolatile memory is ciphered firmware code. Thus, simply copying the contents of the nonvolatile memory will not allow the executable firmware code to be read since the firmware code is ciphered. Moreover, the executable code is executed from the volatile memory, and the volatile memory provides a faster data access time than the nonvolatile memory.

These and other objectives of the claimed invention will no doubt become obvious to those of ordinary skill in the art after reading the following detailed description of the preferred embodiment, which is illustrated in the various figures and drawings.

### BRIEF DESCRIPTION OF DRAWINGS

FIG. 1 is a block diagram of an electronic device according to the present invention.

FIG. 2 is a functional block diagram of a firmware update system according to the first embodiment of the present invention.

FIG. 3 is a flowchart illustrating how the firmware of the electronic device is updated according to the first embodiment of the present invention.

FIG. 4 is a flowchart illustrating how the electronic device deciphers and executes the ciphered firmware code stored in the flash memory.

FIG. 5 is a functional block diagram of a firmware update system according to the second embodiment of the present invention.

FIG. 6 is a flowchart illustrating how the firmware of the electronic device is updated according to the second embodiment of the present invention.

### DETAILED DESCRIPTION

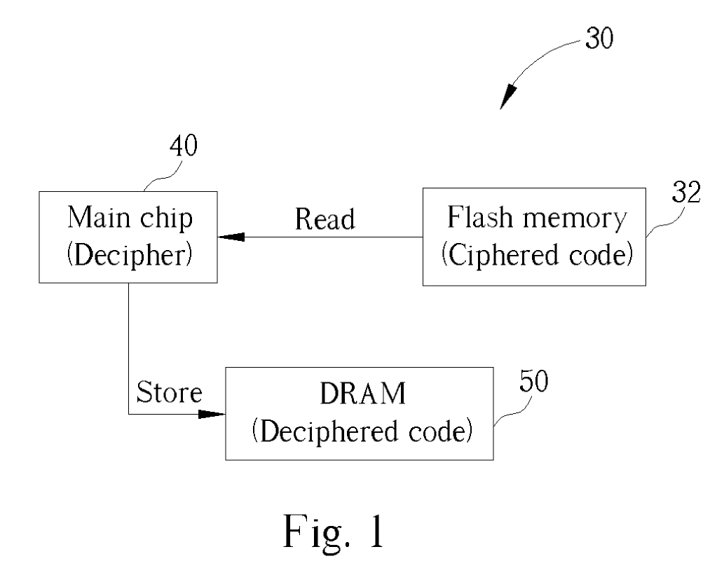

Please refer to FIG. 1. FIG. 1 is a block diagram of an electronic device 30 according to the present invention. The electronic device 30 contains a flash memory 32 or other nonvolatile memory for storing ciphered firmware code. The electronic device 30 can be any kind of device that uses firmware code. For example, the electronic device 30 may be an optical disk drive, a hard drive, or a computer. If the electronic device 30 is a computer, the basic input output system (BIOS) of the computer can be stored in the flash memory 32.

When the electronic device 30 is operated, a main chip 40 reads the ciphered firmware code from the flash memory 32 and deciphers the ciphered firmware code into executable firmware code. The main chip 40 then stores the executable firmware code in a dynamic random access memory (DRAM) 50 or other volatile memory. Thus, the electronic device 30 only stores the executable firmware code in the DRAM 50 temporarily while the electronic device 30 is operated. Once the electronic device 30 is powered off, the contents of the DRAM 50 will be erased, and the executable firmware code will no longer be stored in the DRAM 50. Even though the ciphered firmware code can still be read in the flash memory 32, the ciphered firmware code cannot be deciphered without knowing the decipher key that is required for deciphering the ciphered firmware code.

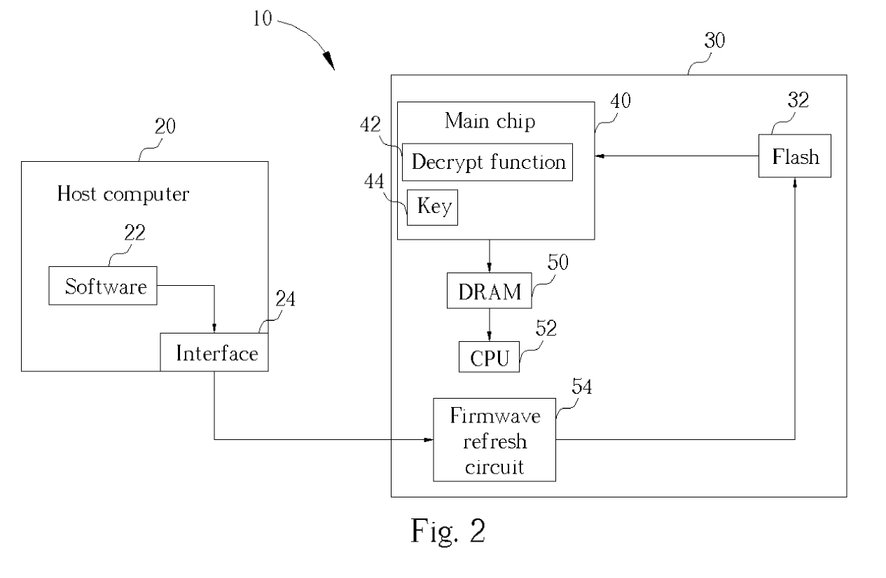

Please refer to FIG. 2. FIG. 2 is a functional block diagram of a firmware update system 10 according to the first embodiment of the present invention. A host computer 20 is connected to the electronic device 30 for updating the firmware of the electronic device 30. A software program 22 installed on the host computer 20 ciphers executable firmware code into ciphered firmware code. The host computer 20 then sends the ciphered firmware code to the electronic device 30 through an interface 24 of the host computer 20. The interface 24 can be any interface such as an IDE, SCSI, USB, or IEEE 1394 interface.

In the first embodiment of the firmware update system 10, the ciphered firmware code is sent through the interface 24 of the host computer 20 to a firmware refresh circuit 54. The firmware refresh circuit 54 replaces the previous contents of the flash memory 32 with the new ciphered firmware code received from the host computer 20. In addition, a decipher key 44 is stored in the main chip 40 of the electronic device 30 to allow the main chip 40 to decipher the ciphered firmware code with a decrypt function 42 of the main chip 40.

The decrypt function 42 of the main chip 40 decrypts the ciphered firmware code stored in the flash memory 32 and outputs the executable firmware code. The executable firmware code is then stored in the DRAM 50. A central processing unit (CPU) 52 of the electronic device 30 executes the executable firmware code that is stored in the DRAM 50, thereby controlling operation of the electronic device 30.

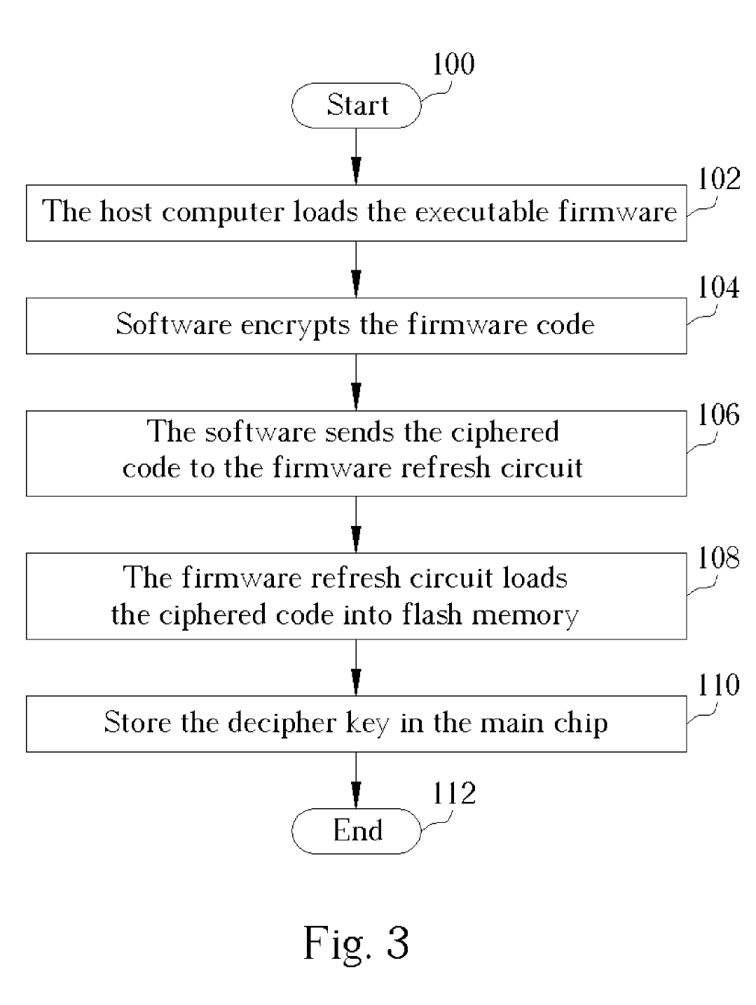

Please refer to FIG. 3 with reference to FIG. 2. FIG. 3 is a flowchart illustrating how the firmware of the electronic device 30 is updated according to the first embodiment of the present invention. Steps contained in the flowchart will be explained below.
Step 100:Start;
Step 102:The host computer 20 loads the executable firmware code that is to be sent to the electronic device 30;
Step 104:The software program 22 encrypts the executable firmware code into ciphered firmware code using a cipher key;
Step 106:The software program 22 of the host computer 20 sends the ciphered firmware code to the firmware refresh circuit 54 of the electronic device 30;
Step 108:The firmware refresh circuit 54 loads the ciphered firmware code into the flash memory 32;
Step 110:The decipher key 44 is stored in the main chip 40 of the electronic device 30; and
Step 112:End.

The cipher key used to cipher the executable firmware code into the ciphered firmware code is the same key as the decipher key 44. As is well known to those skilled in the art, the deciphering and ciphering operations are inverses of each other.

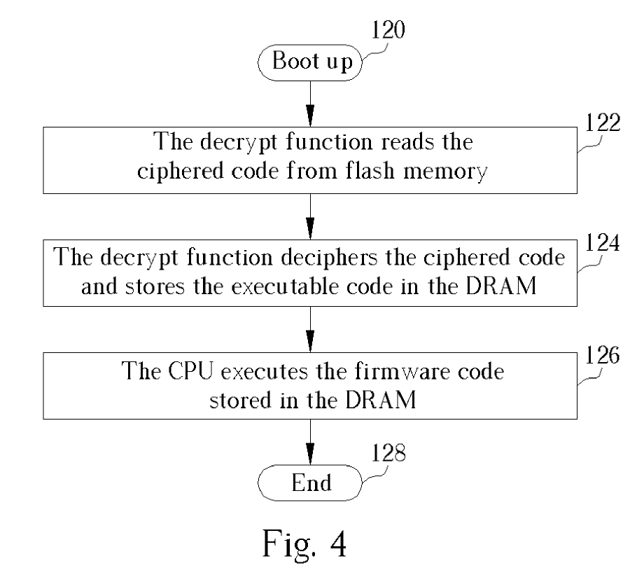

Please refer to FIG. 4 with reference to FIG. 2. FIG. 4 is a flowchart illustrating how the electronic device 30 deciphers and executes the ciphered firmware code stored in the flash memory 32. Steps contained in the flowchart will be explained below.
Step 120:The electronic device 30 boots up;
Step 122:The decrypt function 42 of the main chip 40 reads the ciphered firmware code from the flash memory 32;
Step 124:The decrypt function 42 deciphers the ciphered firmware code using the decipher key 44 and stores the executable firmware code in the DRAM 50;
Step 126:The CPU 52 executes the executable firmware code stored in the DRAM 50 for operating the electronic device 30; and
Step 128:End.

Instead of updating the contents of the flash memory 32 using the firmware refresh circuit 54, other methods exist for updating the firmware of the electronic device 30.

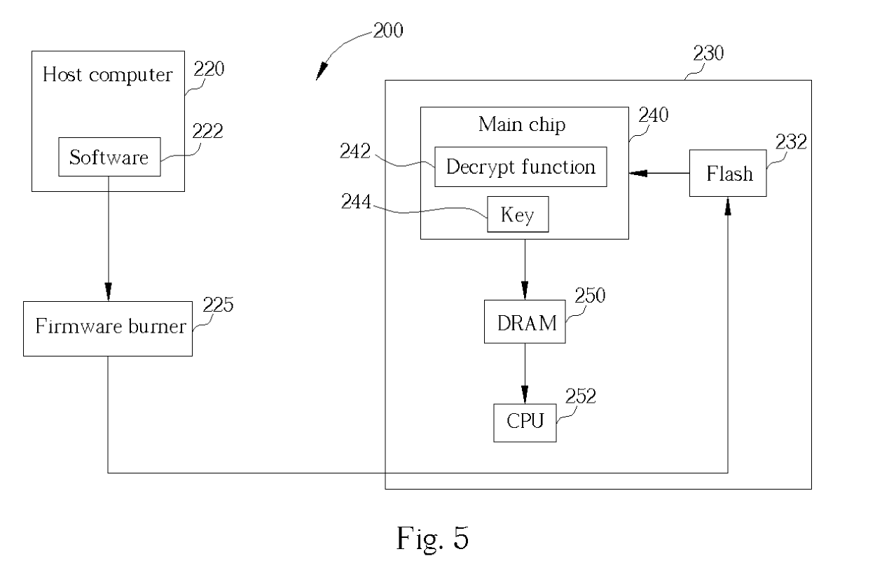

Please refer to FIG. 5. FIG. 5 is a functional block diagram of a firmware update system 200 according to the second embodiment of the present invention. A host computer 220 is connected to an electronic device 230 for updating the firmware of the electronic device 230. A software program 222 installed on the host computer 220 ciphers executable firmware code into ciphered firmware code. The host computer 220 then sends the ciphered firmware code to a firmware burner 225 that updates the contents of a flash memory 232 of the electronic device 230 with the ciphered firmware code. The firmware burner 225 is a special tool that is used for the purpose of flashing the contents of the flash memory 232. In addition, a decipher key 244 is stored in a main chip 240 of the electronic device 230 to allow the main chip 240 to decipher the ciphered firmware code with a decrypt function 242 of the main chip 240.

The decrypt function 242 of the main chip 240 decrypts the ciphered firmware code stored in the flash memory 232 and outputs the executable firmware code. The executable firmware code is then stored in a DRAM 250. A CPU 252 of the electronic device 230 executes the executable firmware code that is stored in the DRAM 250, thereby controlling operation of the electronic device 230.

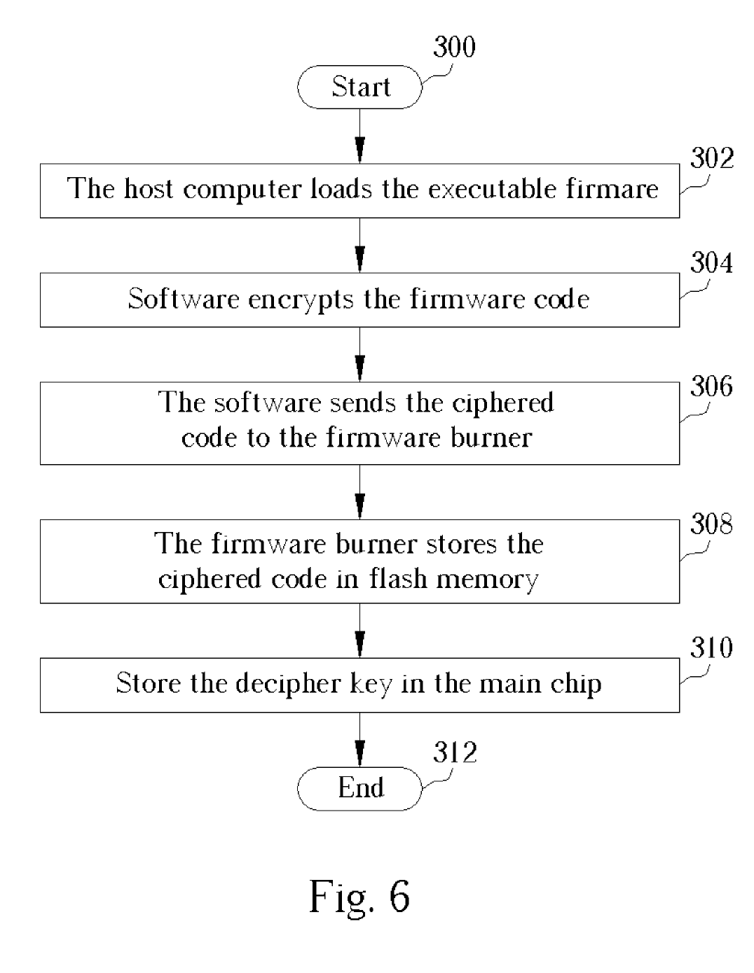

The second embodiment firmware update system 200 differs from the first embodiment firmware update system 10 in the method of updating the contents of the flash memory 232. For a detailed explanation of updating the firmware of the electronic device 230 according to the second embodiment of the present invention, please refer to the flowchart of FIG. 6 with reference to FIG. 5. Steps contained in the flowchart will be explained below.
Step 300:Start;
Step 302:The host computer 220 loads the executable firmware code that is to be sent to the electronic device 230;
Step 304:The software program 222 encrypts the executable firmware code into ciphered firmware code using a cipher key;
Step 306:The software program 222 of the host computer 220 sends the ciphered firmware code to the firmware burner 225;
Step 308:The firmware burner 225 stores the ciphered firmware code in the flash memory 232;
Step 310:The decipher key 244 is stored in the main chip 240 of the electronic device 230; and
Step 312:End.

In contrast to the prior art, the electronic device making use of the present invention method only stores ciphered firmware code in a nonvolatile memory. The ciphered firmware code is decrypted and temporarily stored in a volatile memory only when the electronic device is operated. Therefore, the executable firmware code cannot be read once the electronic device is powered off, and only the ciphered firmware code can be read. Since the value of the decipher key is not commonly known, it is difficult for anyone to read the executable firmware code used by the electronic device. Thus, simply copying the contents of the nonvolatile memory will not allow the executable firmware code to be read since the firmware code is ciphered. Moreover, the executable code is executed from the volatile memory, and the volatile memory provides a faster data access time than the nonvolatile memory.

Those skilled in the art will readily appreciate that numerous modifications and alterations of the device may be made without departing from the scope of the present invention. Accordingly, the above disclosure should be construed as limited only by the metes and bounds of the appended claims.

1. A method of preventing firmware from being pirated, the firmware containing executable code for an electronic device, the method comprising:
ciphering executable firmware code into ciphered firmware code;
storing the ciphered firmware code in a nonvolatile memory of the electronic device;
storing a decipher key in a decrypting circuit of the electronic device;
deciphering the ciphered firmware code with the decrypting circuit of the electronic device to decrypt the executable firmware code;
storing the executable firmware code in a volatile memory of the electronic device; and
executing the executable firmware code stored in the volatile memory for operating the electronic device.

2. The method of claim 1 wherein software installed on a host computer ciphers the executable firmware code into the ciphered firmware code.

3. The method of claim 2 wherein the software installed on the host computer transmits the ciphered firmware code to a firmware refresh circuit of the electronic device and the firmware refresh circuit stores the ciphered firmware code in the nonvolatile memory of the electronic device.

4. The method of claim 2 wherein the software installed on the host computer transmits the ciphered firmware code to a firmware burner, the firmware burner is connected to the electronic device, and the firmware burner stores the ciphered firmware code in the nonvolatile memory of the electronic device.

5. The method of claim 1 wherein the nonvolatile memory is flash memory.

6. The method of claim 1 wherein the volatile memory is dynamic random access memory (DRAM).

7. The method of claim 1 wherein the electronic device is an optical disk drive.

8. The method of claim 1 wherein the electronic device is a hard drive.

9. The method of claim 1 wherein the electronic device is a computer and the executable firmware code is code in a basic input output system (BIOS) of the computer.
